(19) United States
(12) Patent Application Publication
(10) Pub. No.: US 2004/0267789 A1
(43) Pub. Date: Dec. 30, 2004

(54) Apparatus and method for adaptably acquiring attribute information

(75) Inventors: Makoto Miyake, Kawasaki-shi (JP); Takeshi Taniguchi, Tokyo (JP); Naoki Yamakoshi, Yamato-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/864,563

(22) Filed: Jun. 9, 2004

(30) Foreign Application Priority Data
Jun. 11, 2003 (JP) 2003-166847

(51) Int. Cl. G06F 7/00

(52) U.S. Cl. 707/100

(57) ABSTRACT

An attribute acquisition apparatus includes a set attribute storing section for storing the names of multiple set attributes and an attribute name specifying portion selecting section for selecting an attribute name specifying portion which is a row or a column of tabulated data in which each of the names of multiple recorded attributes recorded in tabulated data is recorded. Also provided is an attribute name comparing section for comparing the names of the multiple recorded attributes included in the attribute name specifying portion with the names of the multiple set attributes, and associating each of the recorded attributes with one of the multiple set attributes based on the result of the comparison. The apparatus further includes an attribute information acquiring section for acquiring, for each of multiple sets recorded in the tabulated data, each of multiple pieces of attribute information belonging to that set as attribute information corresponding to the set attribute associated with the recorded attribute of the attribute information. Also encompassed are methods for acquiring and managing attributes consistent with the above apparatus and program products for practicing such a method.

### BACKGROUND OF THE INVENTION

1. Field of the Invention

The present invention relates to an apparatus and method for acquiring attribute information, and a program and a recording medium therefore. Particularly, the present invention relates to such apparatus and method for acquiring, from tabulated data having multiple attribute information sets each of which is composed of multiple pieces of attribute information recorded in a tabulate form, multiple pieces of attribute information recorded in each of the multiple sets, and a program and a recording medium therefore.

2. Background

Information such as setting information on multiple information processing devices connected to a network, customer data on multiple customers, or the like may be managed by spreadsheet software as tabulated data. In such tabulated data, multiple attribute information sets, each of which includes multiple pieces of attribute information, are recorded in a tabulate form. In the case of managing setting information on information processing devices, for example, each of the multiple information processing devices is recorded as a set of multiple pieces of attribute information. As the multiple pieces of attribute information to be included in each set, setting information on the information processing device corresponding to the attribute information set is recorded; such as a ename, IP address, subnet mask, DNS server and the like.

There have been provided some programs for reading such tabulated data and acquiring, for each of the attribute information sets, attribute information recorded in that set to perform various types of processing therewith, such as management of information processing devices and customer management, for example.

A user of a program mentioned above may be sometimes required to input multiple tabulated data into the program. For example, in the case of the management of information processing devices described above, it may occur that the tabulated data is changed every time any change is made to the settings for an information processing device connected to a network, and bulk processing by the above-mentioned program is performed later. In such a case, the user may change the format of the tabulated data by changing the arrangement of the multiple attributes or changing the names of the attributes.

However, if the format is changed, it is impossible for the above-mentioned program to correctly associate the multiple pieces of attribute information in each set with the multiple attributes represented thereby. Therefore, the user has to arrange the changed tabulated data according to the pre-arranged format before inputting the tabulated data into the program, requiring more time and effort on the part of the user.

### SUMMARY OF THE INVENTION

In view of the above, the object of the present invention is to provide an attribute information acquisition apparatus, and associated methods and programs, which can resolve the above problems.

According to a first aspect of the present invention, there is provided an attribute information acquisition apparatus for acquiring, from tabulated data having multiple sets of attribute information composed of multiple pieces of attribute information recorded in a tabulate form, multiple pieces of attribute information recorded in each of the multiple sets. The apparatus comprises a set attribute storing section for storing the name of the set attribute for each of the multiple set attributes preset in advance. Also included is an attribute name specifying portion selecting section for selecting an attribute name specifying portion which is a row or a column of the tabulated data in which, for each of the attributes recorded in the tabulated data, the name of the recorded attribute is recorded; and an attribute name comparing section for comparing the names of the recorded attributes included in the attribute name specifying portion with the names of the multiple set attributes, and associating each of the recorded attributes with one of the multiple set attributes based on the result of the comparison. The apparatus also includes an attribute information acquiring section for acquiring, for each of the multiple sets recorded in the tabulated data, each of the multiple pieces of attribute information belonging to the set as attribute information corresponding to the set attribute associated with the recorded attribute of the attribute information. An associated attribute information acquisition method and program is also disclosed herein.

### BRIEF DESCRIPTION OF THE DRAWINGS

FIG. 1 shows the configuration of an attribute information acquisition apparatus 10 according to an embodiment of the present invention;

FIG. 2 shows an example of tabulated data according to the embodiment of the present invention;

FIG. 3 shows the content of a set attribute storing section 100 according to the embodiment of the present invention;

FIG. 4 shows a process flow of the attribute information acquisition apparatus 10 according to the embodiment of the present invention;

FIG. 5 shows a process flow of the attribute information acquisition apparatus 10 according to the embodiment of the present invention, to be performed at S420;

FIG. 6 shows an example of an association input screen of the attribute information acquisition apparatus 10 according to the embodiment of the present invention, to be displayed at S530; and

FIG. 7 shows an example of the hardware configuration of the attribute information acquisition apparatus 10 according to the embodiment of the present invention.

### DETAILED DESCRIPTION OF EMBODIMENTS OF THE PRESENT INVENTION

Hereinafter, the present invention will be explained by way of description of exemplary embodiments, however, these embodiments should not be read as limiting the invention's scope which shall be delineated solely by the claims appended hereto. In addition, all combinations of characteristics explained in these embodiments are not necessary for each implementation of the invention.

A brief explanation of terminology used herein may be helpful in understanding and interpreting this specification. In discussing embodiments of the present apparatus, the term ‘section’ is often used to describe a particular part or component of the apparatus. This term is to be understood to indicate a functional partition of the apparatus only and not be read as limiting on the embodiment. A ‘section’ of the apparatus may be understood to mean a component, a group of components, a chip or card, a combination of hardware and software such as microcode, or any other portion of the apparatus separable by function or responsibility.

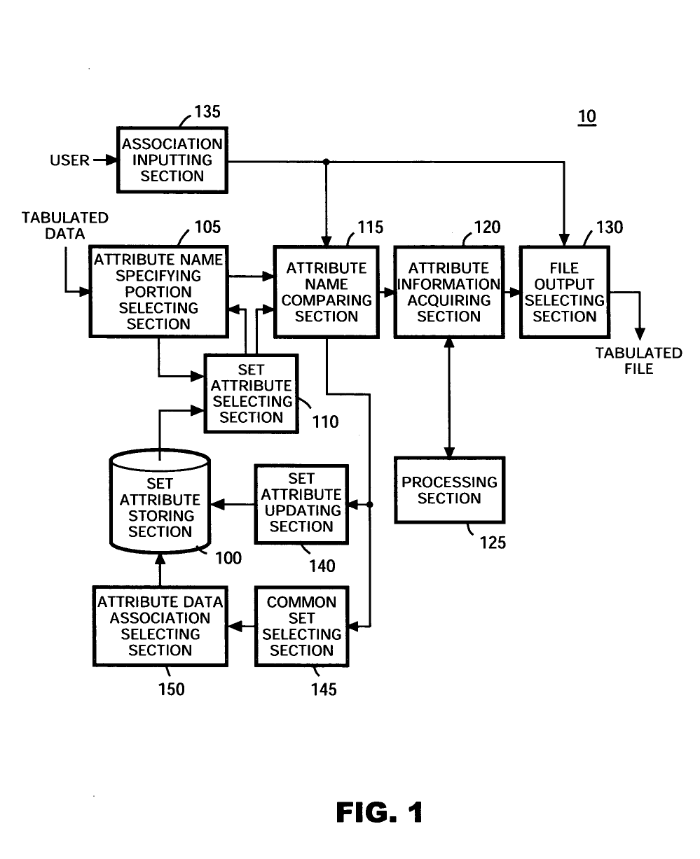

FIG. 1 shows the configuration of an attribute information acquisition apparatus 10 according to the embodiment. The attribute information acquisition apparatus 10 according to this embodiment stores the names of multiple preset attributes in a set attribute storing section 100.. By comparing these names with the names of multiple attributes recorded in tabulated data newly read, the attribute information acquisition apparatus 10 associates the preset multiple attributes with the multiple attributes recorded in the tabulated data. Thus, it is possible for a user to acquire multiple pieces of attribute information recorded in the newly read tabulated data correctly in association with the multiple attributes, without arranging the tabulated data in advance.

The attribute information acquisition apparatus 10 comprises a set attribute storing section 100, an attribute name specifying portion selecting section 105, a set attribute selecting section 110, an attribute name comparing section 115, an attribute information acquiring section 120, a processing section 125, a file output selecting section 130, an association inputting section 135, a set attribute updating section 140, a common set selecting section 145, and an attribute data association setting section 150.

The set attribute storing section 100 stores the name of each of multiple set attributes which are multiple attributes preset in advance. In this case, the set attribute storing section 100 may store multiple set attribute sets each of which is composed of multiple set attributes, such as a first set attribute set composed of first multiple set attributes and a second set attribute set composed of second multiple set attributes, and store the name of each of the multiple set attributes included in each set attribute set.

The attribute name specifying portion selecting section 105 selects, for each of multiple recorded attributes which are attributes recorded in tabulated data newly acquired by the attribute information acquisition apparatus 10, an attribute name specifying portion which is a row or a column of the tabulated data, in which the name of the recorded attribute is recorded. The set attribute selecting section 110 selects, from among the multiple set attribute sets stored in the set attribute storing section 100, a set attribute set which matches the multiple recorded attributes recorded in the acquired tabulated data, and supplies the name of each of the multiple set attributes included in the set attribute set to the attribute name comparing section 115.

The attribute name comparing section 115 compares the names of the multiple recorded attributes included in the attribute name specifying portion selected by the attribute name specifying portion selecting section 105, with the names of the multiple set attributes supplied from the set attribute storing section 100 via the set attribute selecting section 110, and associates each of the recorded attributes with one of the multiple set attributes based on the comparing result. The attribute information acquiring section 120 acquires tabulated data via the attribute name specifying portion selecting section 105 and the attribute name comparing section 115, and acquires, for each of the multiple sets recorded in the tabulated data, each of the multiple pieces of attribute information belonging to the set as attribute information corresponding to the set attribute associated with the recorded attribute of the attribute information.

The processing section 125 acquires, for each of the sets, multiple pieces of attribute information acquired from the tabulated data and associated with multiple set attributes, and processes each set based on the multiple pieces of attribute information in the set. The processing section 125 performs processings on the information acquired from the tabulated data, such as changing a portion of the attribute information and adding a new attribute information set or a new attribute as required. The file output selecting section 130 writes the information acquired by the attribute information acquiring section 120 and updated by the processing section 125 as required, to a tabulated file. In this case, the file output selecting section 130 may select a format of a file to be written based on a direction by the user of the attribute information acquisition apparatus 10.

If the name of one of the recorded attributes does not match any of the names of the multiple set attributes, then the association inputting section 135 causes the user of the attribute information acquisition apparatus 10 to input which of the multiple set attributes the one recorded attribute should be associated with. The attribute name comparing section 115 associates, based on the input by the association inputting section 135, the one recorded attribute with the specified set attribute. The association inputting section 135 also causes the user of the attribute information acquisition apparatus 10 to input a format of a file to be written by the file output selecting section 130 and provides the direction inputted by the user to the file output selecting section 130.

Based on the result of association of the recorded attributes with the set attributes performed by the attribute name comparing section 115, the set attribute updating section 140 updates the set attributes stored in the set attribute storing section 100. In this case, if the attribute information acquisition apparatus 10 sequentially acquires first tabulated data and second tabulated data, the attribute name specifying portion selecting section 105 first selects the attribute name specifying portion of the first tabulated data. Then, the set attribute updating section 140 causes the set attribute storing section 100 to store multiple recorded attribute names included in the attribute name specifying portion in the first tabulated data in the set attribute storing section 100 as multiple set attribute names used for acquiring multiple pieces of attribute information from the second tabulated data.

In the case of sequentially acquiring the first tabulated data and the second tabulated data, the common set selecting section 145 selects a first set in the first tabulated data and a second set in the second tabulated data which are substantially the same sets. The attribute data association setting section 150 associates, for substantially the same two attributes included in the first and second sets selected by the common set selecting section 145, the attribute data in the first set with the attribute data in the second set and causes the set attribute storing section 100 to store them.

As described above, the attribute information acquisition apparatus 10 according to this embodiment makes it possible to select an attribute name specifying portion in acquired tabulated data, compares it with each of multiple set attributes, and associate multiple recorded attributes included in the tabulated data with multiple set attributes. Accordingly, even when any change is made to the format of the tabulated data, the attribute information acquisition apparatus 10 is capable of acquiring, for each of multiple sets recorded in the tabulated data, multiple pieces of attribute information included in the set correctly in association with multiple attributes and causing the processing section 125 to process them.

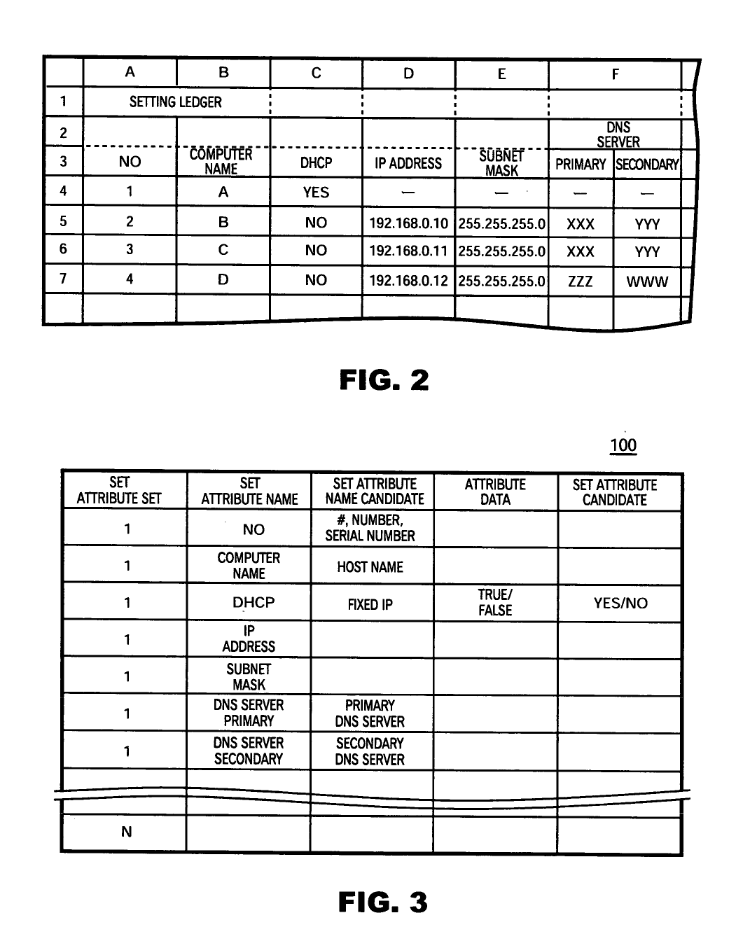

FIG. 2 shows an example of tabulated data according to this embodiment. This tabulated data has multiple columns labeled with A to F and so on, and multiple rows labeled with 1 to 7 and so on. In the cell at column A/row 1, the name of the tabulated data “Setting Ledger” is recorded.

This tabulated data also includes an attribute name specifying portion in which the names of multiple recorded attributes are horizontally arranged. In the tabulated data in FIG. 2, the names of the respective multiple recorded attributes, “No.”, “Computer Name”, “DHCP”, “IP Address”, “Subnet Mask”, “Primary” and “Secondary” are horizontally arranged in row 3.

In this tabulated data, multiple sets are horizontally arranged, and multiple pieces of attribute information belonging to each of the multiple sets are horizontally arranged so that each of them is recorded in a column for which the name of a recorded attribute corresponding to that attribute information is recorded. That is, in the tabulated data in FIG. 2, multiple pieces of attribute information belonging to the “No. 1” set are arranged in row 4, and multiple pieces of attribute information belonging to the “No. 2” set are arrange in row 5. Similarly, multiple pieces of attribute information belonging to the “No. 3” set and those belonging to the “No. 4” are horizontally arranged.

Each attribute information is arranged so that it is recorded in a column for which a recorded attribute name corresponding to that attribute information is recorded. That is, in the tabulated data in FIG. 2, attribute information “A” for Computer Name in the “No. 1” set, attribute information “B” for Computer Name in the “No. 2” set, attribute information “C” for Computer Name in the “No. 3” set, and attribute information “D” for Computer Name in the “No. 4” set are arranged so that they are recorded in column B for which the recorded attribute name “Computer Name” is recorded.

Furthermore, some of the multiple recorded attributes are associated with each of multiple record classifications. That is, in the tabulated data in FIG. 2, multiple record classifications are horizontally arranged in row 2, and the recorded attribute named “Primary” and the recorded attribute named “Secondary” are associated with the record classification named “DNS Server”.

Alternatively, tabulated data may include an attribute name specifying portion in which the names of multiple recorded attributes are vertically arranged. In this case, in the tabulated data, multiple sets are vertically arranged, and multiple pieces of attribute information belonging to each of the multiple sets are vertically arranged so that each attribute information is recorded in a row for which a recorded attribute name corresponding to that attribute information is recorded. The names of the multiple record classifications are vertically arranged.

FIG. 3 shows the content of the set attribute storing section 100 according to this embodiment in a tabulate form. The set attribute storing section 100 stores, in association with each of the multiple set attribute sets, a set attribute name, a set attribute name candidate, attribute data and an attribute data candidate of the respective set attributes belonging to that set attribute set. In this case, the set attribute storing section 100 may further store, for each attribute set, the order of the multiple set attributes.

The “Set Attribute Name” is a field for storing a name specified in association with each of multiple set attributes preset in advance. The “Set Attribute Name Candidate” is a field for storing one or more set attribute name candidates for one set attribute name. For example, in the Set Attribute Name Candidate field associated with the set attribute name “No.” in the set attribute set 1, “#”, “Number” and “Serial Number” are recorded as name candidates which may be used instead of that name.

The “Attribute Data” is a field for storing, if attribute information corresponding to one set attribute is selected in association with the name of that one set attribute from multiple predetermined attribute data, such attribute data. For example, in the Attribute Data field associated with the set attribute name “DHCP” in the set attribute set 1, multiple attribute data to be selected as attribute information for the set attribute, “True” and “False” are recorded.

The “Attribute Data Candidate” is a field for multiple attribute data candidates for multiple attribute data corresponding to one set attribute in association with the name of that one set attribute. For example, in the Attribute Data Candidate field associated with the set attribute name “DHCP” in the set attribute set 1, “Yes” and “No” are recorded as candidates for the attribute data which may be used instead of the attribute data.

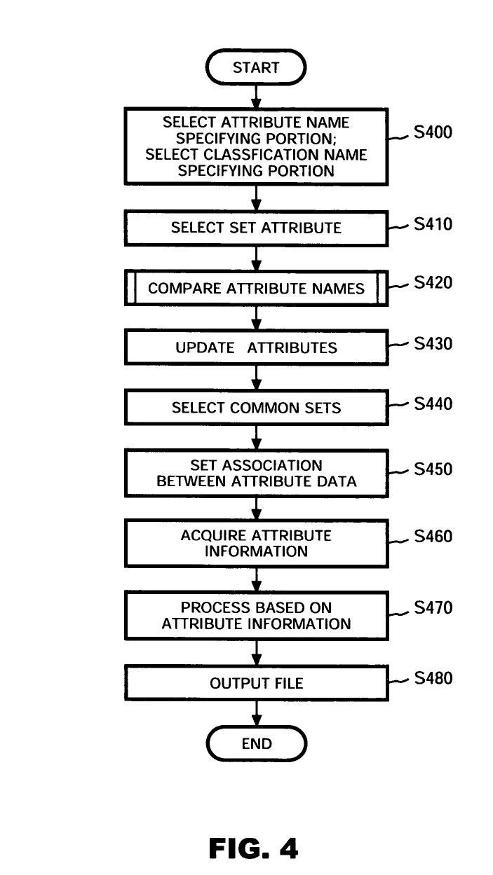

FIG. 4 shows a process flow of the attribute information acquisition apparatus 10 according to this embodiment. First, the attribute name specifying portion selecting section 105 acquires tabulated data. The attribute name specifying portion selecting section 105 then selects an attribute name specifying portion which is a row or a column of the tabulated data in which the names of multiple recorded attributes are recorded, and selects a classification name specifying portion which is a row or a column of the tabulated data in which the names of multiple record classifications recorded in the tabulated data are recorded (S400).

The set attribute selecting section 110 then selects one set attribute set from among multiple set attribute sets stored in the set attribute storing section 100, and provides a name, one or more set attribute name candidates, attribute data, and attribute data candidates of each of the multiple set attributes included in that set attribute set to the attribute name comparing section 115 (S410). In this case, if the number of the names of multiple set attributes in one set attribute set included in the attribute name specifying portion is larger than the number of the names of multiple set attributes in any other set attribute set, then the set attribute selecting section 110 selects that one set attribute set, and supplies the names of the multiple set attributes included in that set attribute set to the attribute name comparing section 115. Thereby, the set attribute selecting section 110 selects to cause the attribute name comparing section 115 to associate recorded attributes with first multiple set attributes.

The attribute name comparing section 115 then compares the names of the multiple recorded attributes included in the attribute name specifying portion with the names of the multiple set attributes provided from the set attribute selecting section 110, and associates each of the recorded attributes with one of the multiple set attributes based on the comparing result (S420).

In this case, if the name of one recorded attribute does not match any of the set attribute names, the association inputting section 135 causes the user to input which of the multiple set attributes the one recorded attribute should be associated with. The attribute name comparing section 115 then associates the one recorded attribute with the selected set attribute.

Then, the set attribute updating section 140 updates the set attributes stored in the set attribute storing section 100 based on the result of the association by the attribute name comparing section 115 (S430). In this case, if the attribute name comparing section 115 associates one recorded attribute with the set attribute selected by the user, the set attribute updating section 140 stores the name of the one recorded attribute in the “Set Attribute Name Candidate” field in the set attribute storing section 100 as a set attribute name candidate for the name of the set attribute associated with the one recorded attribute. Thereby, when new tabulated data is next acquired, the attribute name comparing section 115 can perform comparison using the set attribute name candidate added by the set attribute updating section 140, so that the accuracy of association can be improved.

The set attribute updating section 140 causes the set attribute storing section 100 to store the names of the multiple recorded attributes included in the attribute name specifying portion of the acquired tabulated data as the names of multiple set attributes in a new set attribute set. Thereby, the attribute information acquisition apparatus 10 can increase variations of the tabulated data stored in the set attribute storing section 100 each time it acquires new tabulated data.

Then, when first tabulated data and second tabulated data are sequentially acquired, the common set selecting section 145 selects a first set in the first tabulated data and a second set in the second tabulated data which are substantially the same sets (S440). That is, when the attribute information acquisition apparatus 10 sequentially acquires the first tabulated data and the second tabulated data, the common set selecting section 145 determines whether attribute information corresponding to the same one recorded attribute has been selected from predetermined first multiple attribute data, for each of the multiple sets included in the first tabulated data, and attribute information corresponding to the same one recorded attribute has been selected from predetermined second multiple attribute data, for each of the multiple sets included in the second tabulated data. If this condition is satisfied, the common set selecting section 145 selects such a first set and a second set included in the first tabulated data and the second tabulated data, respectively, that a predetermined number of or more than the predetermined number of pieces of attribute information in the first set match attribute information in the second set corresponding to that attribute information in the first set.

For example, if the first tabulated data and the second tabulated data include the multiple recorded attributes shown in FIG. 2, the attribute information corresponding to one recorded attribute “DHCP” is the one selected from “Yes” and “No” for each of the multiple sets included in the first tabulated data, and the attribute information corresponding to the one recorded attribute “DHCP” is the one selected from “True” and “False” for each of the multiple sets included in the second tabulated data, the common set selecting section 145 selects a first set in the first tabulated data and a second set in the second tabulated data which are substantially the same sets. That is, the common set selecting section 145 selects such a first set and a second set that a predetermined number or more than the predetermined number of pieces of attribute information in the first set match the attribute information in the second set corresponding to the attribute information in the first set.

Specifically, the common set selecting section 145 selects such a second set the attribute information of which matches, for example, six or more among “No.”, “Computer Name”, “DHCP”, “IP Address”, “Subnet Mask”, “Primary” and “Secondary” in the first set. Thus, the common set selecting section 145 selects, for example, {No., Computer Name, DHCP, IP Address, Subnet Mask, Primary, Secondary}={2, B, False, 192.168.0.10,255.255.255.0, XXX, YYY} as a second set for the first set of {No., Computer Name, DHCP, IP Address, Subnet Mask, Primary, Secondary}={2, B, No, 192.168.0.10, 255.255.255.0, XXX, YYY}.

Then, the attribute data association setting section 150 associates the attribute data which is the attribute information corresponding to the above one recorded attribute in the first set selected by the common set selecting section 145, with the attribute data which is the attribute information corresponding to that one recorded attribute in the second set (S450). That is, in the above example, the attribute data “No” which is the attribute information corresponding to the one recorded attribute “DHCP” in the first set, is associated with the attribute data “False” which is the attribute information corresponding to the one recorded attribute “DHCP” in the second set.

The attribute data association setting section 150 then causes the set attribute storing section 100 to store the association between the first multiple attribute data in the first tabulated data and the second multiple attribute data in the second tabulated data. That is, in the above example, the attribute data association setting section 150 causes the multiple attribute data “Yes/No” to be stored in that order in association with the multiple attribute data “True/False” corresponding to the set attribute name “DHCP”.

Thus, the common set selecting section 145 and the attribute data association setting section 150 can associate multiple attribute data recorded in different formats with each other based on the corresponding attribute information of substantially the same multiple sets included in the first tabulated data and the second tabulated data.

Then, the attribute information acquiring section 120 acquires, for each of the multiple sets recorded in the tabulated data, each of multiple pieces of attribute information belonging to that set as attribute information corresponding to the set attribute associated with the recorded attribute of that attribute information (S460).

Then, the processing section 125 acquires, for each of the sets, the multiple pieces of attribute information acquired from the tabulated data and associated with the multiple set attributes, and processes each set based on the multiple pieces of attribute information included in that set (S470). For example, the processing section 125 according to this embodiment may cause the attribute information acquisition apparatus 10 to centrally control settings for multiple information processing devices by setting, for an information processing device specified by the set attribute “Computer Name”, attribute information to be set for the information processing device which can be specified by the set attributes such as “DHCP”, “IP Address”, “Subnet Mask”, “Primary” and “Secondary” based on the tabulated data in FIG. 2.

Then, the file output selecting section 130 selects whether to write the multiple pieces of attribute information acquired by the attribute information acquiring section 120 for each of the multiple sets in a tabulated file in which they are arranged based on the arrangement order of the multiple recorded attributes corresponding to the respective pieces of attribute information in tabulated data, or to write them in a tabulated file in which they are arranged based on the order of the multiple set attributes stored in the set attribute storing section 100, based on a direction by the user of the attribute information acquisition apparatus 10, and then writes them in a file in the selected format (S480). Accordingly, the user can select which file should be outputted by the attribute information acquisition apparatus 10, between the file in which multiple pieces of attribute information acquired for each of the multiple sets are to be arranged in the same arrangement order as the original tabulated data and the file in which they are to be arranged in the order set in the set attribute storing section 100. In this case, the file to be written by the file output selecting section 130 may be the one in which a portion of the attribute information has been changed by the processing section 125, or a new attribute information set has been added as required, or a new attribute has been added.

At S400 described above, the attribute name specifying portion selecting section 105 may first acquire the names of the multiple set attributes from the set attribute storing section 100 or the set attribute selecting section 1 10, and select as an attribute name specifying portion a row or a column including a larger number of the set attribute names from among the multiple rows or columns of the tabulated data. Thereby, the attribute name specifying portion selecting section 105 can select a row or a column which best matches the multiple set attributes stored in the set attribute storing section 100 as an attribute name specifying portion.

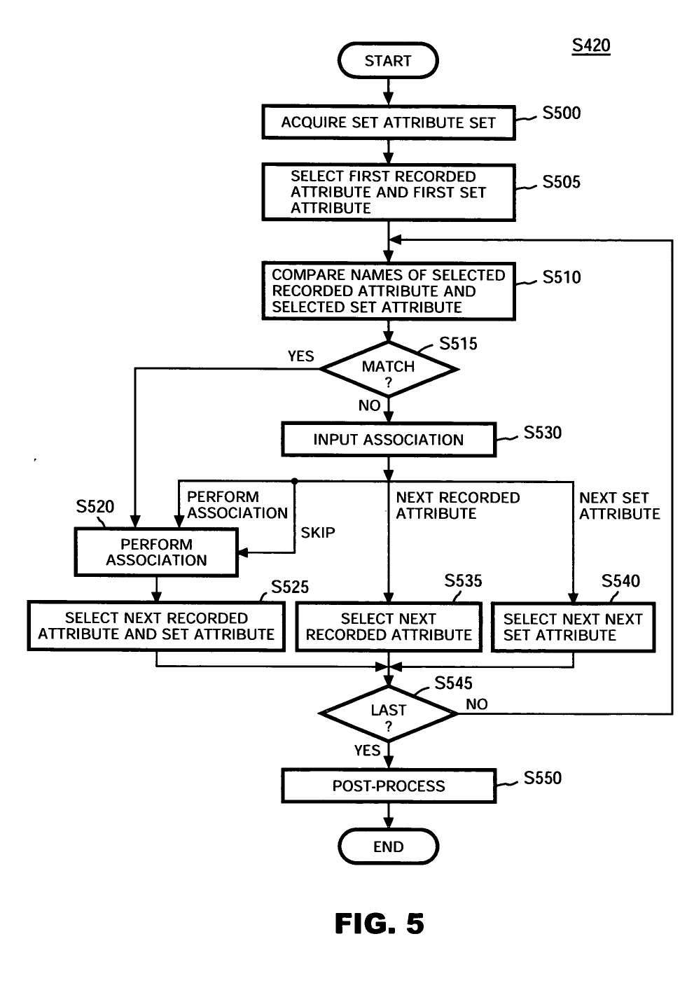

FIG. 5 shows a process flow of the attribute information acquisition apparatus 10 according to this embodiment at S420. First, the attribute name comparing section 115 acquires the name, the set attribute name candidate, the attribute data, and the attribute data candidate of each of the multiple set attributes included in the set attribute set selected by the set attribute selecting section 110 (S500). The attribute name comparing section 115 then selects the first recorded attribute in the order of columns in the tabulated data, from among the multiple recorded attributes, and the first set attribute from the multiple set attributes as a recorded attribute and a set attribute, respectively, which are to be compared with each other (S505).

The attribute name comparing section 115 then compares the name of the one recorded attribute with the name of the one set attribute (S510), both selected at S505. In this comparing, the attribute name comparing section 115 may check whether the name of the one recorded attribute and the name of the one set attribute completely match each other. Alternatively, the same double-byte character and single-byte character may be considered to match each other in the comparing.

If the name of the selected one recorded attribute matches the name of the one set attribute (S515), the attribute name comparing section 115 associates the one recorded attribute with the one set attribute (S520), and selects a recorded attribute next to the one recorded attribute and a set attribute next to the one set attribute as a recorded attribute and a set attribute, respectively, which are to be compared with each other (S525). At S520, the attribute name comparing section 115 may associate the one recorded attribute with the one set attribute after receiving confirmation by the user via the association inputting section 135.

On the other hand, if the name of the selected one recorded attribute does not match the one set attribute name at S515, the association inputting section 135 causes the user of the attribute information acquisition apparatus 10 to input which of the multiple set attributes the one recorded attribute should be associated with (S530). If the association inputting section 135 receives a direction to associate the one recorded attribute with the one set attribute, the attribute name comparing section 115 associates the one recorded attribute with the one set attribute (S520) and selects a recorded attribute next to the one recorded attribute and a set attribute next to the one set attribute as a recorded attribute and a set attribute, respectively, which are to be compared with each other (S525).

If the association inputting section 135 receives a direction to skip the associating operation between the one recorded attribute and the one set attribute, the attribute name comparing section 115 does not associate the one recorded attribute with the one set attribute, and selects a recorded attribute next to the one recorded attribute and a set attribute next to the one set attribute as a recorded attribute and a set attribute, respectively, which are to be compared with each other (S525).

If the association inputting section 135 receives a direction to compare the name of the recorded attribute next to the one recorded attribute with the name of the one set attribute, the attribute name comparing section 115 selects the recorded attribute next to the one recorded attribute as a recorded attribute to be compared (S535). If the association inputting section 135 receives a direction to compare the name of the set attribute next to the one set attribute with the name of the one recorded attribute, the attribute name comparing section 115 selects the set attribute next to the one set attribute as a set attribute to be compared (S540).

The attribute name comparing section 115 repeats the process shown from S510 to S540 until the last set attribute and/or the last recorded attribute has been processed (S545). Thus, the attribute name comparing section 115 sequentially compares the name of one recorded attribute selected in the order of columns in the tabulated data, from among the multiple recorded attributes, and the name of one set attribute selected in the order of setting in the set attribute storing section, from the multiple set attributes with each other at S510. If the name of the one recorded attribute does not match the name of the one set attribute, it can be selected whether to compare the name of the one recorded attribute with the name of the set attribute next to the one set attribute or to compare the name of the recorded attribute next to the one recorded attribute with the name of the one set attribute, based on a direction by the user of the attribute information acquisition apparatus 10.

When the last set attribute and/or the last recorded attribute is processed, the attribute name comparing section 115 performs post-processing such as determination of handling of recorded attributes and/or set attributes which have not been associated in the process described above (S550).

For example, if the association inputting section 135 receives a direction to associate a first recorded attribute and a second recorded attribute with one set attribute from the user of the attribute information acquisition apparatus 10 at the post-processing, the attribute name comparing section 115 associates these recorded attributes with the one set attribute. In response to this, the attribute information acquiring section 120 acquires, for each of the multiple sets recorded in the tabulated data, information including attribute information corresponding to the first recorded attribute and attribute information corresponding to the second recorded attribute in the set as attribute information corresponding to the one set attribute at S460 in FIG. 4.

Also, if the association inputting section 135 receives a direction to associate one recorded attribute with a first set attribute and a second set attribute from the user of the attribute information acquisition apparatus 10, the attribute name comparing section 115 associates different portions of the one recorded attribute with the first set attribute and the second set attribute, respectively. In response to this, the attribute information acquiring section 120 acquires, for each of the multiple sets recorded in the tabulated data, a portion of the attribute information corresponding to the one recorded attribute in the set as attribute information corresponding to the first set attribute and acquires at least a different portion of the attribute information corresponding to the one recorded attribute in the set as attribute information corresponding to the second set attribute. In this case, the attribute information acquiring section 120 may separate the attribute information corresponding to the one recorded attribute with a predetermined delimiter such as a space, a comma or a tab, and associate each of the separated attribute information with a different set attribute. Alternatively, the attribute information acquiring section 120 may separate the attribute information corresponding to the one recorded attribute for each string including a predetermined number of characters, and associate each of the separated attribute information with a different set attribute.

According to the process describe above, the attribute name comparing section 115 compares the names of multiple recorded attributes included in an attribute name specifying portion with the names of multiple set attributes, and rearranges the multiple recorded attributes based on the comparing result to associate each of the recorded attributes with one of the multiple set attributes. The attribute information acquiring section 120 then acquires, for each of the multiple sets recorded in the tabulated data, the result of performing the same rearrangement as the one performed by the attribute name comparing section 115 on multiple pieces of attribute information belonging to that set, as multiple pieces of attribute information corresponding to the respective set attributes. Thereby, the attribute information acquiring section 120 can acquire, for each of the multiple sets recorded in the tabulated data, each of the multiple pieces of attribute information belonging to that set as attribute information corresponding to a set attribute associated with the recorded attribute of the attribute information.

In the above, when comparing the name of the one recorded attribute and the name of the one set attribute selected at S505 with each other, the attribute name comparing section 115 may associate the one recorded attribute with the one set attribute at S520 on condition that the name of the one recorded attribute matches at least one of the name of the one set attribute and the multiple set attribute name candidates.

Also, at S510, the attribute name comparing section 115 may compare, for each recorded attribute for which the record classification name associated with the one recorded attribute is recorded in the classification name specifying portion, the name formed by adding the name of each such recorded attribute to the record classification name associated with that recorded attribute, with the name of each of the multiple set attributes, and associate each such recorded attribute with one of the multiple set attributes based on the comparing result. That is, for example, since the record classification “DNS Server” is recorded in association with the recorded attribute “Primary”, the attribute name comparing section 115 compares the name “DNS Server Primary” or “Primary DNS Server” formed by adding the recorded attribute name “Primary” to the recorded classification name “DNS Server”, with the set attribute names, and associates the recorded attribute with one of the multiple set attributes based on the comparing result.

Furthermore, when a first tabulated data and a second tabulated data are sequentially acquired, the association inputting section 135 may cause the user to input association between attribute data for the two substantially same attributes included in the first tabulated data and the second tabulated data at S530. More specifically, if determining that attribute information corresponding to the same one recorded attribute has been selected from predetermined first multiple attribute data, for each of the multiple sets included in the first tabulated data, and attribute information corresponding to the same one recorded attribute has been selected from predetermined second multiple attribute data, for each of the multiple sets included in the second tabulated data, the association inputting section 135 may cause the user of the attribute information acquisition apparatus 10 to input association between the first multiple attribute data and the second multiple attribute data.

According to the attribute name comparing process described above, the attribute information acquisition apparatus 10 performs association between recorded attributes and set attributes in the order of columns in tabulated data and in the order of set attributes set in the set attribute storing section 100, and causes the user to specify such recorded attributes and/or set attributes for which association is to be skipped, thereby providing a user interface which can easily specify association.

Furthermore, the attribute information acquisition apparatus 10 can associate multiple recorded attributes with one set attribute or associate one recorded attribute with multiple set attributes, so that appropriate association can be performed even if recorded attributes in tabulated data are separated or combined.

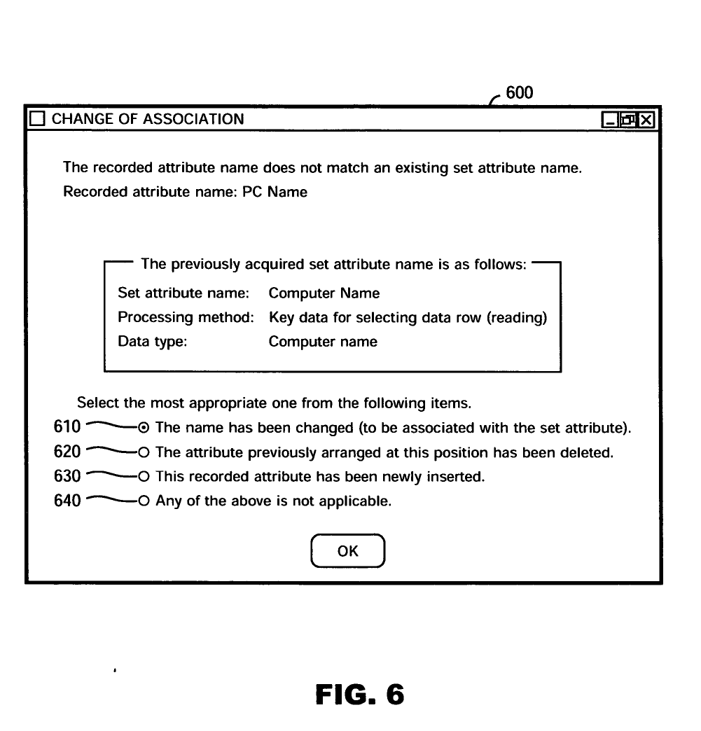

FIG. 6 shows an example of an association input screen of the attribute information acquisition apparatus 10 according to the embodiment of the present invention, to be displayed at S530. An association input window 600 shows that a selected recorded attribute “PC Name” in the tabulated data does not match a selected set attribute “Computer Name”, and causes the user of the attribute information acquisition apparatus 10 to select association.

More specifically, the association input window 600 shows how attribute information corresponding to the selected set attribute “Computer Name” is used by the processing section 125 and what data type the attribute information corresponding to the selected set attribute is assigned as by the processing section 125. The association input window 600 has radio buttons 610, 620, 630 and 640 for causing the user to select association.

The radio button 610 is a button for inputting a direction to associate a selected recorded attribute with a selected set attribute. When the input is performed with the radio button 610, the attribute information acquisition apparatus 10 advances the process to S520. The radio button 620 is a button for inputting an indication that a recorded attribute associated with a set attribute based on the previously acquired tabulated data has been deleted from the current tabulated data. When the input is performed with the radio button 620, the attribute information acquisition apparatus 10 advances the process to S540.

The radio button 630 is a button for inputting an indication that a new recorded attribute has been added to the position of a selected recorded attribute in the tabulated data. When the input is performed with the radio button 630, the attribute information acquisition apparatus 10 advances the process to S535. The radio button 640 is a button for inputting a direction to skip association between a recorded attribute and a set attribute in the case where any of the radio buttons 610, 620 and 630 is not applied. When the input is performed with the radio button 640, the attribute information acquisition apparatus 10 advances the process to S530.

As shown above, the association input window 600 according to this embodiment enables the user of the attribute information acquisition apparatus 10 to select a direction from those provided by the radio buttons 610, 620, 630 and 640 in comparing a recorded attribute with a set attribute, and thereby the user can easily direct association to be performed.

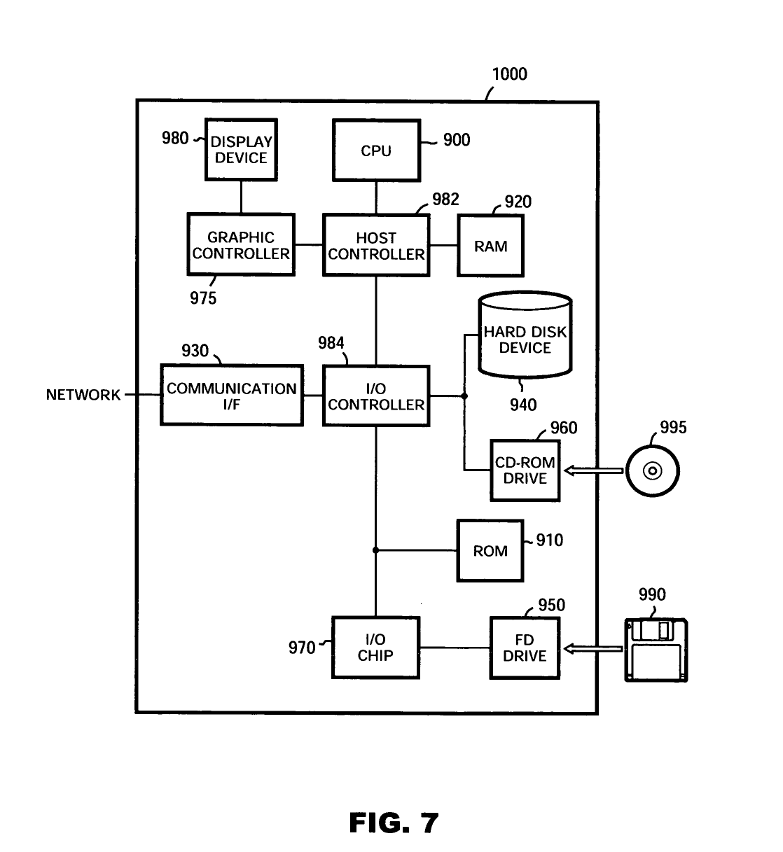

FIG. 7 shows an example of the hardware configuration of the attribute information acquisition apparatus 10 according to this embodiment. A computer 1000 according to this embodiment comprises a CPU related section having a CPU 900, a RAM 920, a graphic controller 975 and a display device 980 mutually connected via a host controller 982, an input/output section having a communication interface 930, a hard disk drive 940 and a CD-ROM drive 960 connected to the host controller 982 via an input/output controller 984, and a legacy input/output section having a ROM 910, a flexible disk drive 950 and an input/output chip 970 connected to the input/output controller 984.

The host controller 982 connects the RAM 920 to the CPU 900 and the graphic controller 975, which access the RAM 920 at a high transfer rate. The CPU 900 operates based on programs stored in the ROM 910 and the RAM 920 to control each section. The graphic controller 975 acquires image data generated by the CPU 900 on a frame buffer provided in the RAM 920, and displays it on the display device 980. Alternatively, the graphic controller 975 may include therein a frame buffer for storing image data generated by the CPU 900.

The input/output controller 984 connects the host controller 982 to the communication interface 930, the hard disk drive 940 and the CD-ROM drive 960, which are relatively high-speed input/output devices. The communication interface 930 communicates with other devices via a network. The hard disk drive 940 stores programs and data to be used by the CPU 900 in the computer 1000. The CD-ROM drive 960 reads a program or data from a CD-ROM 995 and provides it to the hard disk drive 940 via the RAM 920.

The ROM 910 and relatively low-speed input/output devices such as the flexible disk drive 950 and the input/output chip 970 are connected to the input/output controller 984. The ROM 910 stores a boot program to be executed when the computer 1000 is activated and programs dependent on the hardware of the computer 1000. The flexible disk drive 950 reads a program or data from a flexible disk 990 and provides it to the hard disk drive 940 via the RAM 920. The input/output chip 970 connects the flexible disk 990 and various input/output devices via a parallel port, a serial port, a keyboard port, a mouse port and/or other port.

The programs to be installed into the hard disk drive 940 via the RAM 920 are stored in a recording medium such as a flexible disk 990, a CD-ROM 995 or an IC card, and provided by the user. The programs are read from a recording medium, installed in the hard disk drive 940 in the computer 1000 via the RAM 920, and executed by the CPU 900.

The program to be installed in the computer 1000 for causing the computer 1000 to function as the attribute information acquisition apparatus 10 comprises a set attribute storing module, an attribute name specifying portion selecting module, a set attribute selecting module, an attribute name comparing module, an attribute information acquiring module, a processing module, a file output selecting module, an association inputting module, a set attribute updating module, a common set selecting module and an attribute data association setting module. These modules cause the computer 1000 to function as the attribute name specifying portion selecting section 105, the set attribute selecting section 110, the attribute name comparing section 115, the attribute information acquiring section 120, the processing section 125, the file output selecting section 130, the association inputting section 135, the set attribute updating section 140, the common set selecting section 145 and the attribute data association setting section 150, respectively.

The programs and modules described above may be stored in an external storage medium. As the storage medium, an optical recording medium such as a DVD or a PD, a magneto-optical recording medium such as an MD, a tape medium, or a semiconductor memory such as an IC card may be used in addition to the flexible disk 990 and the CD-ROM 995. Furthermore, a storage device such as a hard disk or a RAM provided in a server system connected to a dedicated communication network or the Internet may be used as a recording medium to provide the programs for the computer 1000 via the network.

The present invention has been explained in some detail by describing one or more exemplary embodiments. However, it is to be understood that the scope of the present invention is not restricted to the range of the above-described embodiments. Those skilled in the relevant arts will readily recognize that various changes or modifications may be made to the described embodiments without departing from the scope and spirit of the present invention.

What is claimed is:

1. An attribute information acquisition apparatus for acquiring, from tabulated data having multiple sets of attribute information comprising multiple pieces of attribute information recorded in a tabulate form, said multiple pieces of attribute information recorded in each of said sets, said apparatus comprising:
a set attribute storing section for storing, for each of multiple set attributes preset in advance, the name of the set attribute;
an attribute name specifying portion selecting section for selecting an attribute name specifying portion which is a row or a column of said tabulated data in which, for each of said multiple attributes recorded in said tabulated data, the name of the recorded attribute is recorded;
an attribute name comparing section for comparing the names of said multiple recorded attributes included in said attribute name specifying portion with the names of said multiple set attributes, and associating each of said recorded attributes with one of said multiple set attributes based on a result of the comparison; and
an attribute information acquiring section for acquiring, for each of said multiple sets recorded in said tabulated data, each of said multiple pieces of attribute information belonging to the set as attribute information corresponding to said set attribute associated with said recorded attribute of the attribute information.

2. The attribute information acquisition apparatus according to claim 1, wherein said tabulated data includes said attribute name specifying portion in which the names of said multiple recorded attributes are horizontally arranged, and said multiple pieces of attribute information belonging to each of said multiple sets are vertically arranged so that each of said multiple pieces of attribute information is recorded in a column where the name of the recorded attribute corresponding to that attribute information is recorded;
said set attribute storing section further stores the order of said multiple set attributes;
said attribute name comparing section compares the names of said multiple recorded attributes included in said attribute name specifying portion with the names of said multiple set attributes, and associates each of said recorded attributes with one of said multiple set attributes by rearranging said multiple recorded attributes based on the result of the comparison; and
said attribute information acquiring section acquires, for each of said multiple sets recorded in said tabulated data, a result of performing the same rearrangement as that performed by said attribute name comparing section, on said multiple pieces of attribute information belonging to that set, as multiple pieces of attribute information corresponding to the respective set attributes.

3. The attribute information acquisition apparatus according to claim 2, further comprising a file output selecting section for selecting, based on a direction by a user of said attribute information acquisition apparatus, whether to write a tabulated file in which said multiple pieces of attribute information acquired for each of said multiple sets are arranged in said tabulated data based on the arrangement order of said multiple recorded attributes corresponding to the respective multiple pieces of attribute information or to write a tabulated file in which said multiple pieces of attribute information are arranged based on the order of said multiple set attributes stored in said set attribute storing section.

4. The attribute information acquisition apparatus according to claim 1, further comprising an association inputting section for, if the name of one of said recorded attributes does not match any of the names of said multiple set attributes, causing a user of said attribute information acquisition apparatus to input with which of said multiple set attributes said one recorded attribute should be associated.

5. The attribute information acquisition apparatus according to claim 1, wherein said attribute name comparing section sequentially compares the name of one recorded attribute selected from said multiple recorded attributes in the order of columns of said tabulated data, with the name of one set attribute selected from said multiple set attributes in the order of the setting in said set attribute storing section, and selects, if the name of said one recorded attribute does not match the name of said one set attribute, whether to compare the name of said one recorded attribute with the name of the set attribute next to said one set attribute or to compare the name of the recorded attribute next to said one recorded attribute with the name of said one set attribute, based on a direction by a user of said information acquisition apparatus.

6. The attribute information acquisition apparatus according to claim 1, wherein said set attribute storing section further stores multiple set attribute name candidates for the name of one of said set attributes in association with the name of said one set attributes; and
said attribute name comparing section associates, when comparing the name of one of said recorded attributes with the name of said one set attribute, said one recorded attribute with said one set attribute if the name of said one recorded attribute matches at least one of the name of said one set attribute and said multiple set attribute name candidates.

7. The attribute information acquisition apparatus according to claim 6, further comprising:
an association inputting section for, if the name of said one recorded attribute does not match any of the names of said multiple set attributes, causing a user of said attribute information acquisition apparatus to input with which of said multiple set attributes said one recorded attribute should be associated; and
a set attribute updating section for causing said set attribute storing section to store the name of said one recorded attribute as the set attribute name candidate for the name of said set attribute associated with said one recorded attribute.

8. The attribute information acquisition apparatus according to claim 1, wherein said attribute name specifying portion selecting section selects said attribute name specifying portion in a first tabulated data; and
said attribute information acquisition apparatus further comprises a set attribute updating section for causing said set attribute storing section to store the names of said multiple recorded attributes included in said attribute name specifying portion in said first tabulated data as the names of said multiple set attributes used for acquiring said multiple pieces of attribute information from a second tabulated data.

9. The attribute information acquisition apparatus according to claim 8, further comprising an association input section for, if determining that attribute information corresponding to the same one recorded attribute has been selected from predetermined first multiple attribute data, for each of said multiple sets included in said first tabulated data, and that attribute information corresponding to the same one recorded attribute has been selected from predetermined second multiple attribute data, for each of said multiple sets included in said second tabulated data, causing the user of said attribute information acquisition apparatus to input association between said first multiple attribute data and said second multiple attribute data.

10. The attribute information acquisition apparatus according to claim 8, further comprising:
a common set selecting section for, if determining that attribute information corresponding to the same one recorded attribute has been selected from predetermined first multiple attribute data, for each of said multiple sets included in said first tabulated data, and that attribute information corresponding to the same one recorded attribute has been selected from predetermined second multiple data, for each of said multiple sets included in said second tabulated data, selecting first and second sets included in said first tabulated data and said second tabulated data, respectively, in which at least a predetermined number of pieces of attribute information in said first set match those pieces of attribute information in said second set corresponding to said pieces of attribute information in said first set; and
an attribute data association setting section for associating said first attribute data which is attribute information of said one recorded attribute in said first set, with said second attribute data which is attribute information of said one recorded attribute in said second set.

11. The attribute information acquisition apparatus according to claim 1, wherein said attribute name specifying portion selecting section selects, as said attribute name specifying portion, a row or a column of said tabulated data including larger number of names of said multiple set attributes.

12. The attribute information acquisition apparatus according to claim 1, wherein some of said multiple recorded attributes recorded in said tabulated data are associated with each of multiple record classifications;
said attribute name specifying portion selecting section selects, for each of said multiple record classifications recorded in said tabulated data, a classification name specifying portion which is a row or a column of said tabulated data in which the name of that record classification is recorded; and
said attribute name comparing section compares names made by adding the names of said multiple recorded attributes to the name of the record classification associated therewith, with the names of said multiple set attributes, and associates each of said recorded attributes with one of said multiple set attributes based on the result of the comparison.

13. The attribute information acquisition apparatus according to claim 1, wherein, upon receiving a direction from a user of said attribute information acquisition apparatus to associate a first recorded attribute and a second recorded attribute with one of said set attributes, said attribute information acquiring section acquires, for each of said multiple sets recorded in said tabulated data, information including attribute information corresponding to said first recorded attribute and attribute information corresponding to said second recorded attribute in that set as attribute information corresponding to said one set attribute.

14. The attribute information acquisition apparatus according to claim 1, wherein, upon receiving a direction from a user of said attribute information acquisition apparatus to associate one of said recorded attributes with a first recorded attribute and a second recorded attribute, said attribute information acquiring section acquires, for each of said multiple sets recorded in said tabulated data, a portion of attribute information corresponding to said one recorded attribute in that set as attribute information corresponding to said first set attribute, and acquires at least another portion of the attribute information corresponding to said one recorded attribute in that set as attribute information corresponding to said second set attribute.

15. The attribute information acquisition apparatus according to claim 1, wherein said set attribute storing section further comprises a set attribute selecting section for, if the number of the names of first multiple set attributes included in said attribute name specifying portion is larger than the number of the names of second multiple set attributes, causing said attribute name comparing section to associate said multiple recorded attributes with said first multiple set attributes.

16. An attribute information acquisition method for acquiring, from tabulated data having multiple sets of attribute information composed of multiple pieces of attribute information recorded in a tabulate form, said multiple pieces of attribute information recorded in each of said sets, said method comprising:
storing, for each of multiple set attributes preset in advance, the name of the set attribute;
selecting an attribute name specifying portion which is a row or a column of said tabulated data in which, for each of multiple attributes recorded in said tabulated data, the name of the recorded attribute is recorded;
comparing the names of said multiple recorded attributes included in said attribute name specifying portion with the names of said multiple set attributes, and associating each of said recorded attributes with one of said multiple set attributes based on the comparing result; and
acquiring, for each of said multiple sets recorded in said tabulated data, each of said multiple pieces of attribute information belonging to the set as attribute information corresponding to said set attribute associated with said recorded attribute of the attribute information.

17. A computer-readable medium comprising computer-readable program instructions embodied thereon which are effective when executing to acquire, from tabulated data having multiple sets of attribute information composed of multiple pieces of attribute information recorded in a tabulate form, said multiple pieces of attribute information recorded in each of said sets, said program instructions comprising:
computer-readable program instructions effective when executing to select an attribute name specifying portion which is a row or a column of said tabulated data in which, for each of multiple attributes recorded in said tabulated data, the name of the recorded attribute is recorded;
computer-readable program instructions effective when executing to compare the names of said multiple recorded attributes included in said attribute name specifying portion with the names of said multiple set attributes, and to associate each of said recorded attributes with one of said multiple set attributes based on the comparing result; and
computer-readable program instructions effective when executing to acquire, for each of said multiple sets recorded in said tabulated data, each of said multiple pieces of attribute information belonging to the set as attribute information corresponding to said set attribute associated with said recorded attribute of the attribute information.
